(19) United States
(12) Patent Application Publication
(10) Pub. No.: US 2004/0010929 A1
(43) Pub. Date: Jan. 22, 2004

(54) Roofing shingle gauge

(76) Inventor: David Whitford, Erie, PA (US)

Correspondence Address: RICHARD K THOMSON, ATTORNEY, 7691 FAIRLANE DRIVE, FAIRVIEW, PA, 16415

(21) Appl. No.: 10/199,689

(22) Filed: Jul. 18, 2002

(51) Int. Cl. G01D 21/00

(52) U.S. Cl. 33/649

(57) ABSTRACT

A generally rectangular block has a front end forming a first edge stop for engaging an edge of a shingle to position it in a subsequent course of roofing shingles prior to nailing. A recess in the bottom face has a second edge stop spaced from the first edge stop by a length L₁, the amount equal to a preferred amount of a first course of roofing shingles exposed below a subsequent course. A protruding flange extends outwardly from the front end and preferably tapers providing a resting surface to enable easy manipulation of the loose end of the shingle without unduly distorting the shingle.

### BACKGROUND AND SUMMARY OF THE INVENTION

The present invention is directed to a tool that can be used to facilitate installation of roofing shingles. More particularly, the present invention is directed to a roofing shingle gauge which may be utilized to quickly and precisely place a subsequent course of shingles atop an earlier installed course.

Perhaps the most critical factor in installing a new shingle roof is to ensure that the courses are properly aligned on the roof. Even the slightest misalignment will be amplified over a 30-60 foot run and may be further exacerbated by the installation of subsequent shingle courses. Such a misalignment can necessitate a major tear-off or, in the case of a “do-it-yourselfer”, a neighborhood eyesore being left in place in lieu of expending the extra time to redo the shingle installation properly.

A number of attempts have been made to provide a tool to assist a roofer in combating misalignment. For example, U.S. Pat. Nos. 1,750,854 to Nelson, 2,887,781 to Mills, and 4,110,911 to Sucheck disclose adjustable templates which may be used in positioning shingles. For the most part, shingle sizes have been standardized and the need for adjustment obviated. Accordingly, each of these devices is unnecessarily bulky, complicated and expensive, in addition to being difficult to use. U.S. Pat. No. 4,584,775 to Boman teaches the use of a roofing square 10 and a cap cutter and alignment tool 20 which are used conjunctively to position shingles. As can be seen in FIG. 3 of that patent, the method by which these two tools are used together may result in their being “built into” the roof and misplaced. Further, since each shingle is nailed over the top of the two tools, extricating them from the roof for use on a subsequent shingle is a problem.

The present invention overcomes the difficulties associated with these failed attempts to provide a suitable alignment tool. The roofing shingle gauge of the present invention comprises a generally rectangular block of material, a top edge of the generally rectangular block of material defining a first edge stop. A flange extends upwardly from a top, rear edge portion of the generally rectangular block of material. A recess is formed in a rear surface of said generally rectangular block of material defining a second edge stop. A length L₁ of said generally rectangular block extends between the first end stop and the second end stop, the length L₁ being equal to a preferred amount of a first course of roofing shingles exposed below a subsequent course; whereby the roofing shingle gauge may be placed upon a shingle in the first course of roofing shingles with the second edge stop engaging a lower edge of that shingle and a shingle in the subsequent course laid over the shingle in the first course engaging the first edge stop to properly position the shingle in the subsequent course relative the shingle in the first course.

The recess in the rear surface comprises a surface portion tapering toward a front face beginning in a region generally opposite the first edge stop extending for the length L₁ to the second stop. Preferably, the protruding flange thins toward its distal end to facilitate its insertion and removal from, under the shingle being installed. Means, in the form of a through bore is provided to suspend said roofing shingle gauge from a user's belt.

Various other features, advantages and characteristics will become apparent after a reading of the following detailed description of the preferred embodiments.

### BRIEF DESCRIPTION OF THE DRAWINGS

The preferred embodiment(s) of the present invention are set forth in the drawings, like items bearing like reference numerals and in which

FIG. 1 is a side view of a first embodiment of the roofing shingle gauge of the present invention;

FIG. 2A is a top view of the first embodiment;

FIG. 2B is rear view of the first embodiment;

FIG. 2C is a front view of the first embodiment; and

FIG. 3 is top view depicting the first embodiment of the shingle gauge being used to install a subsequent course of shingles over an existing course.

### DETAILED DESCRIPTION OF THE PREFERRED EMBODIMENT(S)

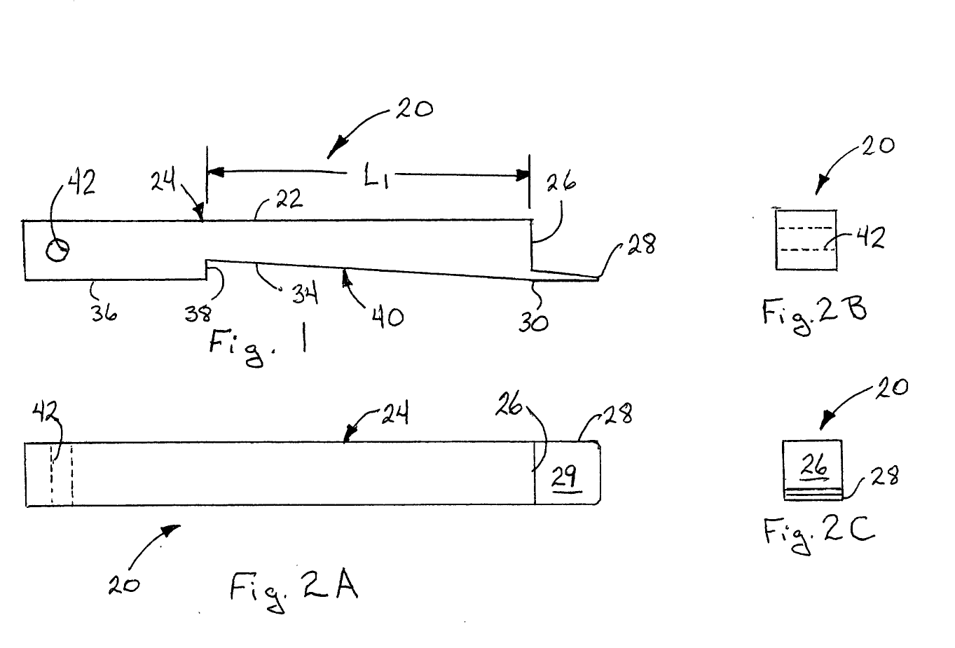

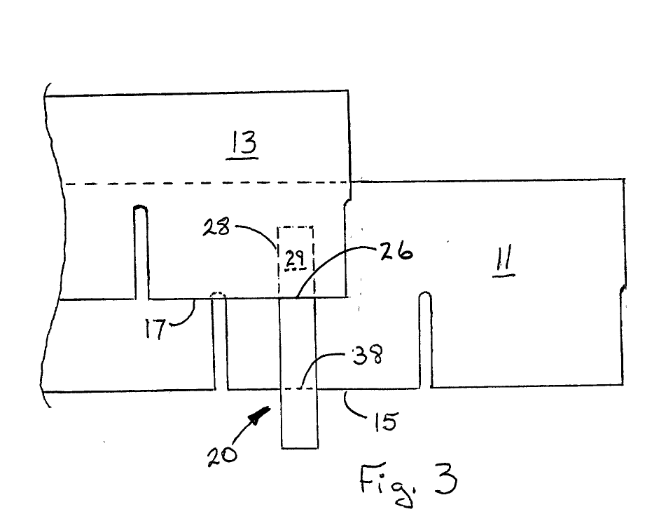

A first embodiment of the roofing shingle gauge of the present invention is shown in FIGS. 1-3 generally at 20. Gauge 20 comprises a generally rectangular body 24 of material which, in the preferred embodiment, is a plastic such as HDPE SR (high density polyethylene). A front end 26 forms a first edge stop. Protruding flange 28 extends outwardly from a lower portion 30 of front end 26. Preferably, flange 28 tapers (thins) toward its distal end 32. In this manner, flange 28 provides a support surface 29 for the loose end of shingle 13 while minimally influencing its position as the subsequent shingle course is being positioned over installed shingle 11 (FIG. 3). A recess 34 is formed in a bottom surface 36 defines a second edge stop 38. Second edge stop 38 is separated from the first edge stop 26 by a length L₁ that is equal to a preferred amount of a first course of roofing shingles exposed below a subsequent course. Currently, in conventional shingles, that amount is 5½″. Should shingle sizes be altered, obviously L₁ could be made different sizes for different shingles. Recess 34 is formed by a surface portion 40 tapering toward a top face 22 beginning in a region generally opposite said first edge stop 26 throughout length L₁ to edge stop 38. Means (shown here as a through bore) 42 is provided to permit shingle gauge 20 to be attached to the roofer's belt, either by hanging it on a hook or tying a cord there through.

In using shingle gauge 20, shingle 13 is positioned over the top of earlier installed shingle 11 and a nail inserted near the left end of shingle 13. Typically, eyeballing the position of the left end of the shingle 13 is not the problem. It may readily be properly positioned by examination. However, should proper positioning of the left end be a problem, shingle gauge 20 may be utilized near the left edge of shingle 13 prior to nail insertion. Normally, once the first nail has been installed, shingle gauge 20 is positioned near the right edge of shingle 13 with second edge stop 38 abutting lower edge 15 of shingle 11 and flange 28 inserted under lower edge 17 of shingle 13. Surface 29 of flange 28 slightly lifts shingle 13 off of shingle 11 and enables it to be easily positioned in proper alignment firmly abutting edge stop 26 prior to being nailed in place. It will be understood that the method described here is for shingling left to right; when the roofer is proceeding right to left across the roof, the terms left and right will, of course, be reversed.

Roofing shingle gauge 20 can be cheaply manufactured and is easy to use as compared to some of the prior art devices designed to perform similar functions. While adept at solving the problem, gauge 20 of the present invention is elegant in its simplicity.

Various changes, alternatives and modifications will become apparent to one of ordinary skill in the art after reading the foregoing specification. It is intended that all such changes, alternatives and modifications as come within the scope of the appended claims be considered part of the present invention.

I claim:

1. A gauge for applying roofing shingles comprising
a) a generally rectangular block of material, a front end of said generally rectangular block of material defining a first edge stop;
b) a protruding flange extending outwardly from a bottom portion of said front end generally rectangular block of material;
c) a recess formed in a bottom surface of said generally rectangular block of material defining a second edge stop, a length L₁ of said generally rectangular block between said first edge stop and said second edge stop, said length L₁ being equal to a preferred amount of a first course of roofing shingles exposed below a subsequent course;
whereby said roofing shingle gauge may be placed upon a shingle in the first course of roofing shingle with the second edge stop engaging a lower edge of that shingle and a shingle in the subsequent course laid over the shingle in the first course engaging said first edge stop to properly position the shingle in the subsequent course relative the shingle in the first course.

2. The shingle gauge of claim 1 wherein said recess in said bottom surface comprises a surface portion tapering toward a top face beginning in a region generally opposite said first edge stop throughout said length L₁ to said second edge stop.

3. The shingle gauge of claim 1 wherein said protruding flange thins toward its distal end.

4. The shingle gauge of claim 1 further comprising means to suspend said roofing shingle gauge from a user's belt.
